(19) United States
(12) Patent Application Publication
(10) Pub. No.: US 2016/0213957 A1
(43) Pub. Date: Jul. 28, 2016

(54) Breathing Mask

(71) Applicant: Lu Xu, Xiamen (CN)

(72) Inventor: Lu Xu, Xiamen (CN)

(21) Appl. No.: 14/604,804

(22) Filed: Jan. 26, 2015

(51) Int. Cl. A62B 23/02; A62B 18/10; A62B 18/02

(52) U.S. Cl. CPC A62B 23/025; A62B 18/02; A62B 18/10

(57) ABSTRACT

A breathing mask includes a shell body, an inner lining mounted behind the shell body, a filtering piece mounted between the shell body and the inner lining, an inner cover mounted behind the inner lining, and a sealing pad coupled with the inner cover. The inner lining has a vent hole and a recess. The inner cover has an air intake and an air outlet.

Ambient air inhaled through a breathing mask user's nasal cavity is introduced into through-holes in the shell body, the filtering piece, the vent hole, and the air intake. Gas exhaled from a mask user's oral cavity is guided into the recess from the air outlet of the inner cover and dissipated via a notch in the recess's bottom. The breathing mask is able to effectively filter harmful substances such as microbes and airborne particles in air inhaled while providing smooth inhalation and exhalation.

### BACKGROUND OF THE INVENTION

The present invention relates to a breathing mask and, more particularly, to a main structure of a breathing mask used in covering a mask user's mouth and nose to filter inhaled air.

To protect themselves and others, people in hospitals, workplaces or daily lives usually wear breathing masks to cover mouths and noses, avoiding harmful substances to be inhaled or exhaled as well as pathogen transmission. Currently, there are several types of breathing masks available in the market because of frequent uses of breathing masks. The conventional breathing masks, however, still present some problems as follows:

1. Gauze masks which are criticized for their poor airtightness struggle in isolating powders, microbes or airborne particles despite functions such as absorption and screening of ambient mouth foam. To some extent, powders, microbes or airborne particles inhaled through respiratory tracts may hurt a human body.

2. Other breathing masks (e.g., N95 respirator) made of fine material feature better airtightness and coverage but work when a mask user exerts more strength to inhale or exhale through the breathing mask. As thus, these breathing masks are not employed conveniently because some carbon dioxide exhaled still remains in the breathing masks and is inhaled by a mask user who continues breathing arduously to resupply more oxygen.

### BRIEF SUMMARY OF THE INVENTION

Therefore, an objective of the present invention is to provide a breathing mask which avoids drawbacks of conventional breathing masks and features preferable coverage on a mask user's mouth and nose to effectively filter harmful substances such as microbes and airborne particles in air inhaled for smooth inhalation and exhalation.

To achieve this and other objectives, a breathing mask of the present invention includes a shell body, an inner lining, a filtering piece, an inner cover, and a sealing pad. The shell body has a plurality of through-holes therein. The inner lining is engaged on a rear side of the shell body and includes a plurality of protuberances thereon. A vent hole is formed in the inner lining and in communication with the through-holes of the shell body. A recess is provided in a lower portion of the inner lining, and a notch is formed in a bottom of the recess. The filtering piece is installed inside the shell body and between the shell body and the inner lining, with the plurality of protuberances of the inner lining resisting the filtering piece. The inner cover is engaged with and mounted behind the inner lining. An insert edge is formed around a periphery of the inner cover and has a plurality of slots therein. An air intake is opened in the inner cover and in communication with the vent hole of the inner lining. An air outlet is provided in the inner cover and in communication with the recess of the inner lining. A valve is covered outside the air outlet. The sealing pad is coupled with the inner cover for covering a mask user's mouth and nose. The sealing pad includes a groove in which the insert edge of the inner cover is engaged, and a plurality of convex portions is provided in the groove and coupled with the slots in the insert edge.

In a preferred form, the filtering piece includes a surface layer, an intermediate layer, and a back layer. The surface layer is a polypropylene nano-zinc non-woven fabric layer, the intermediate layer is a high-density meltblown non-woven fabric layer, and the back layer is a hydrophilic ultra-fine composite fabric layer.

In a preferred form, each of two sides of the inner cover is provided with a connecting portion through which a cable tie penetrates.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 is an exploded perspective view of a breathing mask according to an embodiment of the present invention.

FIG. 2 is an exploded perspective view of a shell body, a filtering piece and an inner lining of the breathing mask of FIG. 1.

FIG. 3 is a perspective view which illustrates an inner cover and a sealing pad of the breathing mask of FIG. 1.

FIG. 4 is a plan view which illustrates the inner cover of FIG. 3.

FIG. 5 is a front view of the breathing mask of FIG. 1.

FIG. 6 is a sectional view taken along plane I-I in FIG. 5.

### DETAILED DESCRIPTION OF THE INVENTION

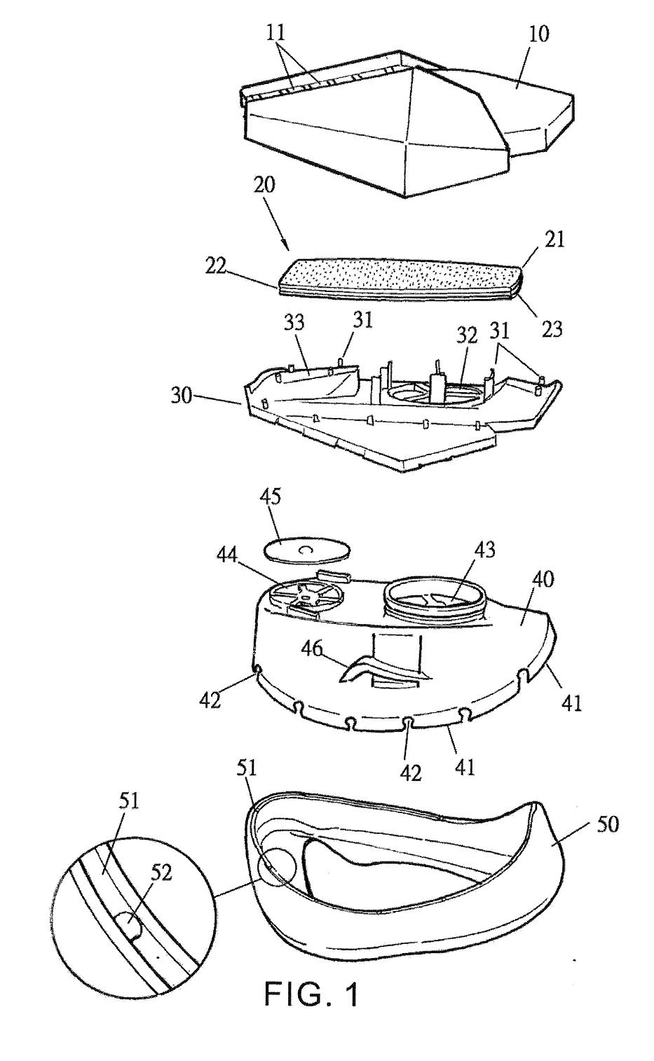

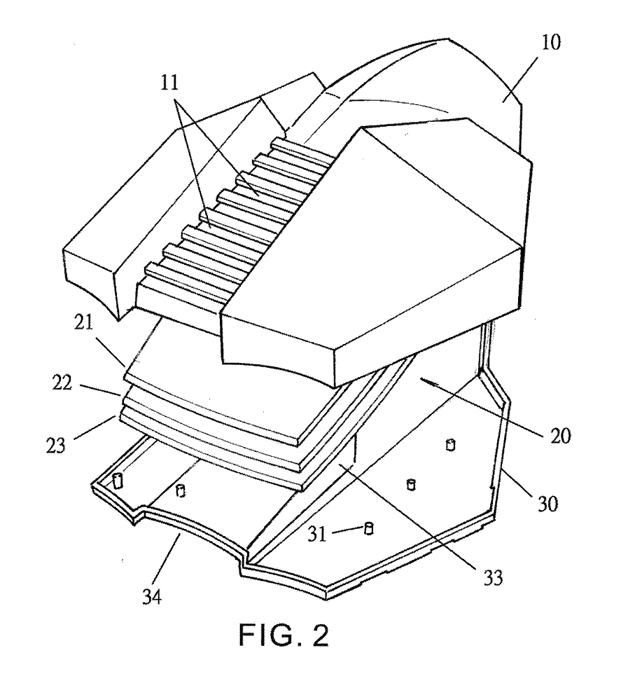

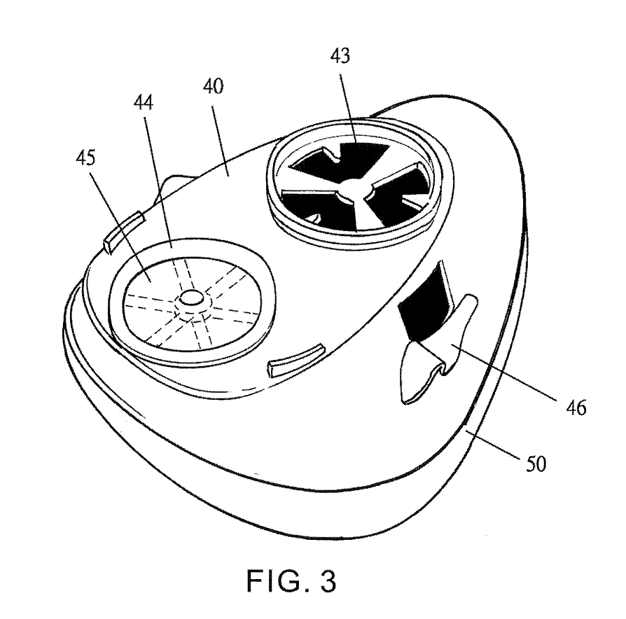

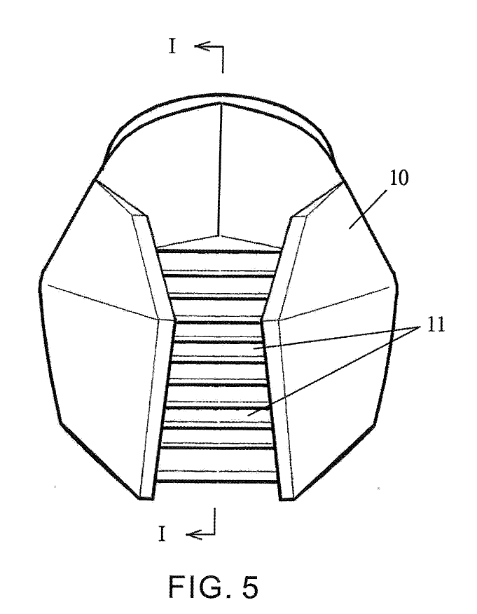

A breathing mask according to the present invention is shown in FIGS. 1-6 of the drawings and includes a shell body 10, a filtering piece 20, an inner lining 30, an inner cover 40, and a sealing pad 50.

The shell body 10 includes a plurality of through-holes 11 in a lower portion thereof. The through-holes 11 are opposite to the mouse and nose of a mask user on whom the breathing mask is covered.

The filtering piece 20 is installed inside the shell body 10 and has an area corresponding to the through-holes 11. The filtering piece 20 is used in sterilizing air introduced from the through-holes 11. In the embodiment, the filtering piece 20 includes a surface layer 21, an intermediate layer 22, and a back layer 23. The surface layer 21 is a polypropylene nano-zinc non-woven fabric layer which is effective in dust filtration, airborne particle filtration, bacteriostasis, sterilization, anti-virus infection, water repellency, and anti-moisture permeability. The intermediate layer 22 is a high-density meltblown non-woven fabric layer which is capable of filtering bacteria, isolating haze, and preventing cross infection. The back layer 23 is a hydrophilic ultra-fine composite fabric layer which contributes to absorption of exhaled breath and features dry but non-sticky feeling while contacting skins.

The inner lining 30 corresponding to the contour of the shell body 10 is engaged on a rear side of the shell body 10. The filtering piece 20 is installed between the shell body 10 and the inner lining 30 on which there is a plurality of protuberances 31 resisting the filtering piece 20 for no shift of the filtering piece 20. A vent hole 32 is formed in the inner lining 30 and in communication with the through-holes 11 of the shell body 10. A recess 33 is provided in a lower portion of the inner lining 30, and a notch 34 is formed in a bottom of the recess 33. When the breathing mask is worn on a mask user's face, the vent hole 32 and the recess 33 are opposite to the user's nasal cavity and oral cavity, respectively.

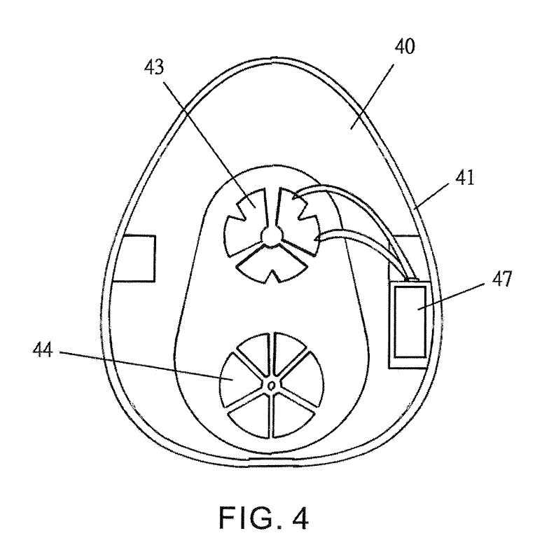

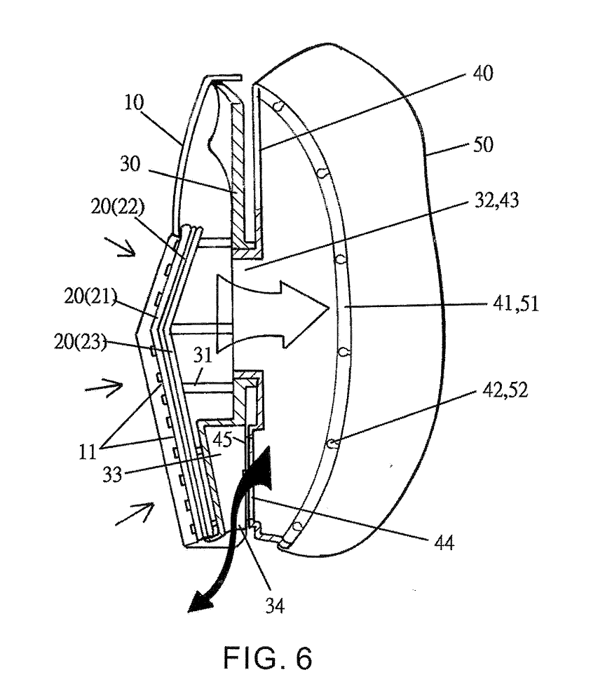

The inner cover 40 is engaged with and mounted behind the inner lining 30. A laminar insert edge 41 is formed around a rear periphery of the inner cover 40 and includes a plurality of slots 42 therein. An air intake 43 is opened in the inner cover 40 and opposite to the vent hole 32 of the inner lining 30 (see FIG. 6). At a lower portion of the inner cover 40 are designed an air outlet 44 and a one-way valve 45. The air outlet 44 is opposite to the recess 33 of the inner lining 30 with the valve 45 mounted outside the air outlet 44, allowing ambient air not to be introduced into the inner cover 40 through the air outlet 44 but gas in the inner cover 40 to be dissipated with the valve 45 opened outwards. The inner cover 40 at each of two sides is provided with a connecting portion 46 through which a cable tie (not shown in figures) penetrates so that the breathing mask can be worn on a mask user's face. Furthermore, the inner cover 40 is optionally provided with an anion generator 47 therein (see FIG. 4) that applies negative high DC voltages (from 5 to 7.0KV) on metallic needles or carbon fibers around which air is ionized as anions and effectively purifies air by charging and depositing particles, powders and smog in the atmosphere.

The sealing pad 50 is used to cover a mask user's mouth and nose. A rear periphery of the sealing pad 50 has a contour matching a facial surface and includes a groove 51 in which the insert edge 41 of the inner cover 40 is engaged. A plurality of convex portions 52 is provided in the groove 51 and coupled with the slots 42 in the insert edge 41, so that the sealing pad 50 securely joins the inner cover 40. Preferably, the sealing pad 50 is made of non-toxic odourless silicone which features good absorbability, stable chemical properties, water/solvent insoluble, good mechanical properties, less deformation or degradation, good airtightness, and comfort for a mask user.

The breathing mask of the present disclosure is characteristic of the sealing pad 50 adhering to a mask user's face and covering his/her mouth and nose. Ambient air inhaled through a mask user's nasal cavity will be introduced into the through-holes 11 in the shell body 10, the filtering piece 20, the vent hole 32, and the air intake 43. Gas exhaled from a mask user's oral cavity will be guided into the air outlet 44 of the inner cover 40, the one-way valve 45, the recess 33 in the inner lining 30, and the notch 34 in the bottom of the recess 33 sequentially.

The breathing mask of the present invention has advantages as follows:

1. Ambient air introduced into major through-holes 11 in the shell body 10 and the filtering piece 20 can be smoothly inhaled by one mask user who experiences less pressure.

2. Carbon dioxide exhaled by one mask user is introduced into the recess 33 of the inner lining 30 from the air outlet 44 and the valve 45 and dissipated via the notch 34 without oxygen deficit, attributed to carbon dioxide inhaled by the mask user.

3. The filtering piece 20 including the surface layer 21, the intermediate layer 22 and the back layer 23 features triple filtrating and protecting functions for effective filtration of powders and airborne particles, bacteriostasis, sterilization, and anti-virus infection. Moreover, the back layer 23 is a hydrophilic ultra-fine composite fabric layer which features dry but non-sticky feeling while contacting skins.

4. The sealing pad 50 provides a mask user with airtight comfort.

5. The anion generator 47 mounted inside the inner cover 40 ionizes air inhaled in the inner cover 40 to be anions for further fresh purified feeling.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims.

1. A breathing mask comprising:
a shell body including a plurality of through-holes therein;
an inner lining engaged on a rear side of the shell body and including a plurality of protuberances thereon, with a vent hole formed in the inner lining and in communication with the through-holes of the shell body, with a recess provided in a lower portion of the inner lining, with a notch formed in a bottom of the recess;
a filtering piece installed inside the shell body and between the shell body and the inner lining, with the plurality of protuberances of the inner lining resisting the filtering piece;
an inner cover engaged with and mounted behind the inner lining, with a insert edge formed around a rear periphery of the inner cover and including a plurality of slots therein, with an air intake opened in the inner cover and being in communication with the vent hole of the inner lining, with an air outlet provided in a lower portion of the inner cover and in communication with the recess of the inner lining, with a valve covered outside the air outlet; and
a sealing pad coupled with the inner cover for covering a mask user's mouth and nose, with the sealing pad including a groove in which the insert edge of the inner cover is engaged, with a plurality of convex portions provided in the groove and coupled with the slots in the insert edge.

2. The breathing mask as claimed in claim 1, wherein the filtering piece includes a surface layer, an intermediate layer, and a back layer, with the surface layer being a polypropylene nano-zinc non-woven fabric layer, with the intermediate layer being a high-density meltblown non-woven fabric layer, with the back layer being a hydrophilic ultra-fine composite fabric layer.

3. The breathing mask as claimed in claim 1, wherein each of two sides of the inner cover is provided with a connecting portion through which a cable tie penetrates.

4. The breathing mask as claimed in claim 1, wherein the inner cover is provided with an anion generator therein that applies negative high DC voltages on metallic needles or carbon fibers around which air is ionized as anions.

5. The breathing mask as claimed in claim 1, wherein the sealing pad is made of silicone.
